(19) United States
(12) Patent Application Publication
(10) Pub. No.: US 2006/0169299 A1
(43) Pub. Date: Aug. 3, 2006

(54) Handle system for disposable flossers

(76) Inventors: John M. Jansheski, Maryville, TN (US); Gary Blouse, Moraga, CA (US); Eric Mowell, Maryville, TN (US); Lex Shankle, Maryville, TN (US)

Correspondence Address: LUEDEKA, NEELY & GRAHAM, P.C., P O BOX 1871, KNOXVILLE, TN, 37901, US

(21) Appl. No.: 11/048,615

(22) Filed: Feb. 1, 2005

(51) Int. Cl. A61C 15/00

(52) U.S. Cl. 132/323

(57) ABSTRACT

A handle system for use with a disposable flosser having an elongate flosser handle to fixedly and replaceably receive the flosser. The system includes an auxiliary handle having a blind bore; a cap movably mounted to the auxiliary handle adjacent the blind bore and defining a channel; and a flexible member received within the channel and the blind bore of the auxiliary handle and configured for receiving a portion of the flosser handle. The cap is movable between first and second positions to urge the flexible member against the flosser handle when the flosser handle is received within the flexible member so as to frictionally retain the flosser handle.

### FIELD OF THE INVENTION

This invention relates generally to dental hygiene devices. More particularly, this invention relates to handle devices for use with disposable flossers.

### BACKGROUND AND SUMMARY OF THE INVENTION

Disposable flossers are widely used dental hygiene devices. Many disposable flossers are relatively compact and it has been observed that the small handle commonly provided on disposable flossers is often difficult to grasp. A need therefor exists for a larger and reusable handle device that can be used with disposable flossers to facilitate their use.

With regard to the foregoing, the present invention is directed to a handle system for use with a disposable flosser having an elongate flosser handle to fixedly and replaceably receive the flosser.

In a preferred embodiment, the system includes an auxiliary handle having a blind bore; a cap movably mounted to the auxiliary handle adjacent the blind bore and defining a channel; and a flexible member received within the channel and the blind bore of the auxiliary handle and configured for receiving a portion of the flosser handle. The cap is movable between first and second positions to urge the flexible member against the flosser handle when the flosser handle is received within the flexible member so as to frictionally retain the flosser handle.

In another aspect, the invention relates to a flossing system having a flosser with a handle and an handle system for cooperating with the flosser handle.

In a preferred embodiment, the handle system includes an auxiliary handle, a cap rotatably connected to the auxiliary handle between a first position and a second position and having a first interior dimension and a second smaller interior dimension, and a flexible member configured for receiving a portion of the flosser handle and received within a retainer statically positioned relative to the auxiliary handle.

When the cap is in the first position the first interior dimension of the cap cooperates with the retainer to enable the flosser handle to be freely insertable through an aperture of the cap for receipt by the flexible member. When the cap is rotated to the second position the second and smaller interior dimension of the cap bears against portions of the retainer to urge the flexible member against the flosser handle to fixedly restrain the flosser handle from movement relative to the handle system.

### BRIEF DESCRIPTION OF THE DRAWINGS

Further features of preferred embodiments of the invention will become apparent by reference to the detailed description of preferred embodiments when considered in conjunction with the figures, which are not to scale, wherein like reference numbers, indicate like elements through the several views, and wherein,

FIG. 1 is a perspective view of a handle system according to a preferred embodiment of the invention.

FIG. 2 is a partial exploded view of the system of FIG. 1.

FIG. 3 is an exploded perspective view showing components of the handle system of FIGS. 1 and 2.

FIG. 4A is a perspective view of a front cap component of the system of FIG. 1; FIG. 4B is a front end view of the cap of FIG. 4A; FIG. 4C is a cross-sectional view taken along line 4C-4C of FIG. 4B; and FIG. 4D is a cross-sectional view taken along line 4D-4D of FIG. 4B.

FIG. 5A is a perspective view of a flosser gripper component of the handle system of FIG. 1 and FIG. 5B is a side view thereof.

FIG. 6A is a perspective view of a gripper retainer component of the handle system of FIG. 1 and FIG. 6B is a cross-sectional side view thereof.

FIG. 7A is a side view of a shell component of a handle portion of the system of FIG. 1. FIG. 7B is a cross-sectional view of the handle portion of FIG. 7A taken along line 7B-7B; and FIG. 7C is a cross-sectional view taken along line 7C-7C.

FIG. 8 is an exploded side view of grip components of the handle portion of the system of FIG. 1.

FIG. 9 is a side view showing the grip components of FIG. 8 installed on the shell component of FIG. 7A.

### DETAILED DESCRIPTION

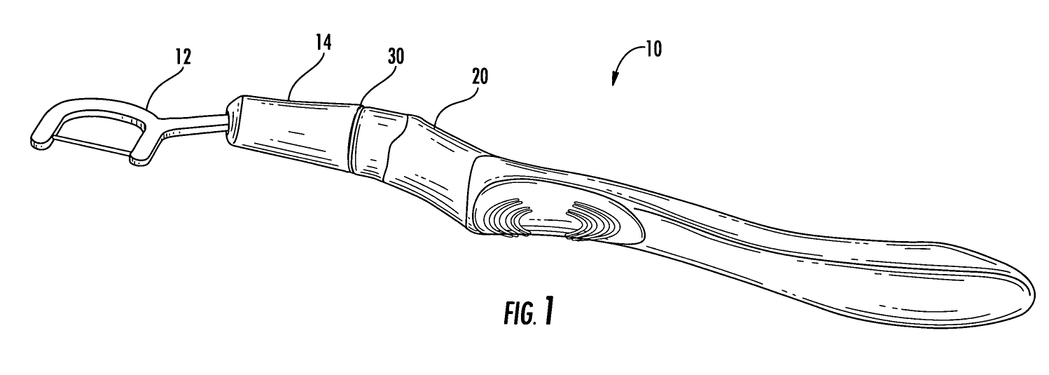

With initial reference to FIGS. 1-3, the invention relates to a flosser handle system 10 configured for releasably retaining a disposable flosser 12. The system 10 preferably includes a front cap 14, a flosser gripper 16, a gripper retainer 18, and a handle 20. The system 10 advantageously receives and fixedly retains a disposable flosser to facilitate use of the flosser. The used flosser may then be easily removed from the handle system 10 for disposal, and a new flosser 12 installed.

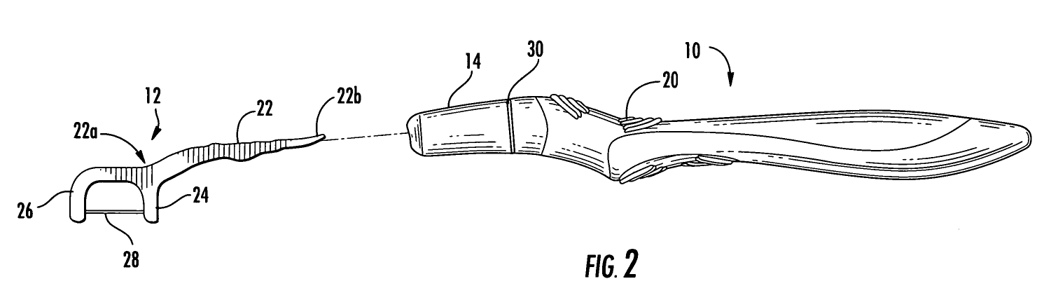

With reference to FIG. 2, the flosser 12 is preferably a plastic disposable flosser available from DenTek Oral Care, Inc. of Maryville, Tenn. The flosser 12 includes a handle 22 and a pair of arms 24 and 26 extending from a distal end 22a of the handle 22. Floss 28 extends between the arms 24 and 26. The handle 22 has a length L of about 2 inches, and of decreasing taper from the distal end 22a to proximal end 22b. In this regard, the proximal end 22b is preferably configured to serve as a toothpick. Such flossers are advantageous to provide portable and effective flossing devices, yet their small size and the taper of the handle can make them hard to grip and manipulate for some users during flossing. Accordingly, the handle system 10 provides an auxiliary and reusable handle structure that may be used with the flosser 12.

With reference to FIG. 3, wherein the components are shown exploded from the assembled state. In the assembled state, the gripper retainer 18 is partially received within the handle 20, with the flosser gripper 16 fully received within the retainer 18 to provide a gripper/retainer assembly. The cap 14 is installed on the handle to surround the exposed portion of the gripper/retainer assembly and can rotate between two positions. A ring 30 is preferably provided to facilitate desired spacing and connection of the cap 14 to the handle 20.

As explained more fully below, the handle 22 of the flosser 12 is passed through an aperture defined in the front of the cap 14 and is received by the gripper/retainer assembly. The cap 14 is then rotated from a first position to a second position. The interior geometry of the cap is selected so that rotation of the cap squeezes the gripper/retainer assembly so as to bear the gripper 16 against the handle to frictionally engage the flosser 12 from movement.

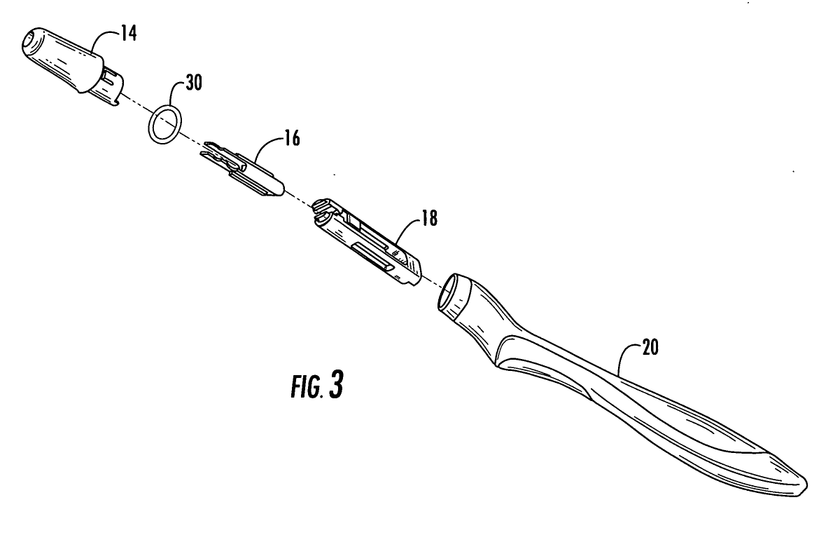

With reference to FIGS. 4A-4D, the cap 14 is preferably of one-piece molded plastic construction and configured to define an elongate and substantially cylindrical interior channel 40 extending from a rear end 41 to a front end 42 where a front aperture 43 is defined. A pair of raised channel sidewall portions 44a and 44b are preferably defined on portions of the channel 40 adjacent the front end 42 to provide structure for reducing the effective diameter of the channel so that when the cap 14 is rotated from the first position to the second position the channel 40 is rotated about the gripper/retainer assembly so that the sidewall portions 44a and 44b are placed in contact with the gripper/retainer assembly and squeeze the gripper/retainer assembly sufficiently to grip the handle 22 of the flosser 12. Thus, when the cap 14 is in the first position, the gripper/retainer assembly is within the diameter D1. When the cap 14 is rotated to the second position, the gripper/retainer assembly is within the smaller diameter D2. For the purpose of example, the diameter D1 of the channel 40 is preferably about 7.2 mm and the diameter D2 is preferably about 6.2 mm. While the cap is described configured for rotational manipulation, it will be understood that it could be configured to enable other motion to effect dimensional variation, such as pulling or pushing the cap toward and away from the handle 20.

The cap 14 defines a mounting shaft 45 adjacent the rear end 41 sized to fit within the handle 20. A shaft extension 45a preferably extends from the shaft 45 for cooperating with the interior geometry of the handle 20 during rotation of the cap 14 between first and second positions, as explained more fully below. A pair of flexible mounting tabs 46a and 46b are preferably defined on opposite sides of the shaft 45 to facilitate mounting of the cap 14 onto the handle 20. The cap 14 also preferably includes a thicker head portion 47 extending from the mounting shaft 45 to the front end 42, such that a shoulder 48 is defined at the juncture of the shaft 45 and the head 47. The shoulder 48 is positioned adjacent the handle 20 and the exterior diameter of the head portion 47 is preferably substantially the same as the exterior portion of the handle 20 to which it is adjacent when installed to provide a smooth interface.

With reference to FIGS. 5A-5B, the gripper 16 is preferably of one-piece molded construction and made of a flexible polymeric material such as rubber and the like. The gripper 16 is preferably substantially U-shaped and includes a pair of substantially spaced apart and mutually facing legs 50 and 51. The legs 50 and 51 are joined together at one end by a bend 52 and by a web 53 bridging between one of the common side edges of the legs along a rear end of the gripper 16 adjacent the bend 52. Elongate fins 54 and 55 are defined along the outer edges of the legs 50 and 51, respectively, adjacent the web 53. Ripples or other rugous topographies 56 and 57 are preferably defined along the inner mutually facing surfaces of the legs 50 and 51 from adjacent the web 53 to the free ends of the legs for frictionally engaging the handle 22 of the flosser 12 when the handle 22 is received within elongate channel 58 defined by the retainer 16 and, in particular, when the gripper 16 is squeezed against the handle 22.

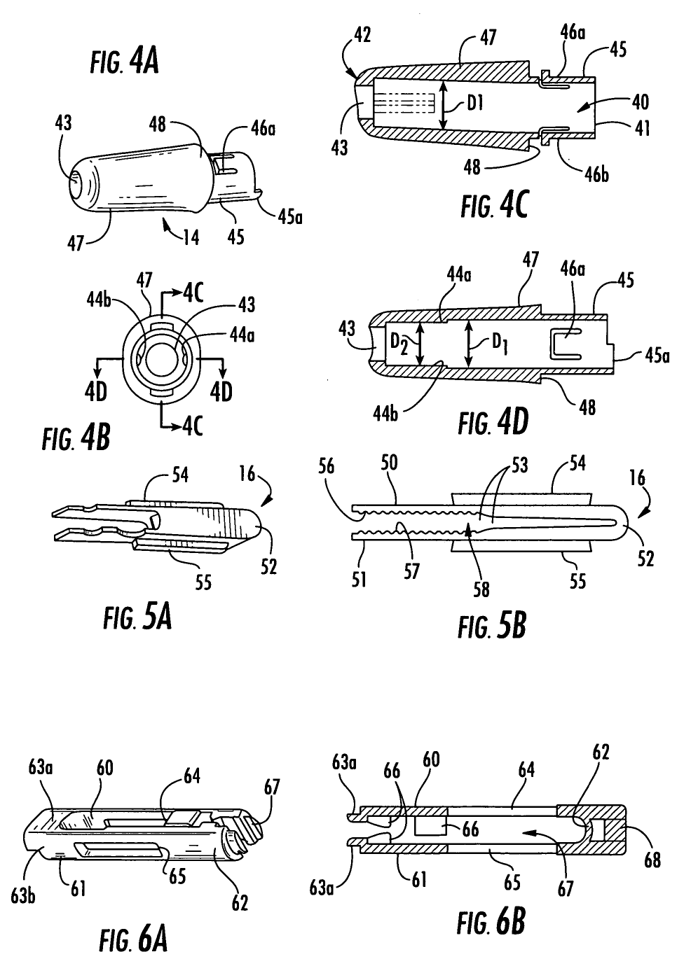

With reference to FIGS. 6A-6B, the gripper retainer 18 is preferably of one-piece molded plastic construction. The gripper retainer 18 is preferably substantially U-shaped and includes a pair of substantially spaced apart and mutually facing legs 60 and 61 joined together at one end by a bend 62. A pair of lips 63a and 63b are defined at the free ends of the legs 60 and 61 and sized so as to fit within the aperture 43 when the retainer 18 is received within the cap 14. Elongate slots 64 and 65 are defined along the legs 60 and 61, respectively, for receiving the fins 54 and 55, respectively, when the gripper 16 is received by the gripper retainer 18. In addition, one or more extensions 66 preferably extend from a side edge of the legs 60 or 61 or both to help maintain the gripper 16 in linear alignment with the retainer 18 and retained within interior cavity 67 of the gripper retainer 18.

The exterior of the retainer 18 is preferably somewhat cylindrical and sized to substantially correspond to the diameter D1 of the cap 14, but slightly smaller so that it can be slidably received within the cap 14. The legs 60 and 61 are urged toward one another when the cap 14 is rotated to the second position and the retainer 18 is exposed to the smaller D2 diameter of the cap 14. In this regard, it is preferred that the retainer 18 remain static relative to the handle 20 and not rotate when the cap 14 is rotated from the first position to the second position. To facilitate this, a notch 68 is preferably defined adjacent the rear end of the gripper retainer 18 which is received within the handle 20 for cooperating with corresponding structure of the handle 20 to statically seat the gripper retainer 18 within the handle 20.

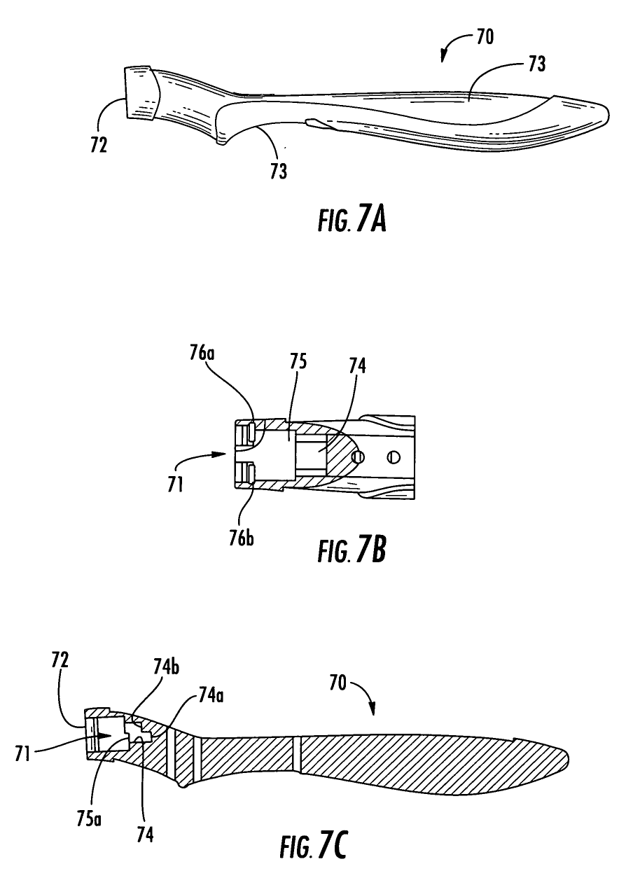

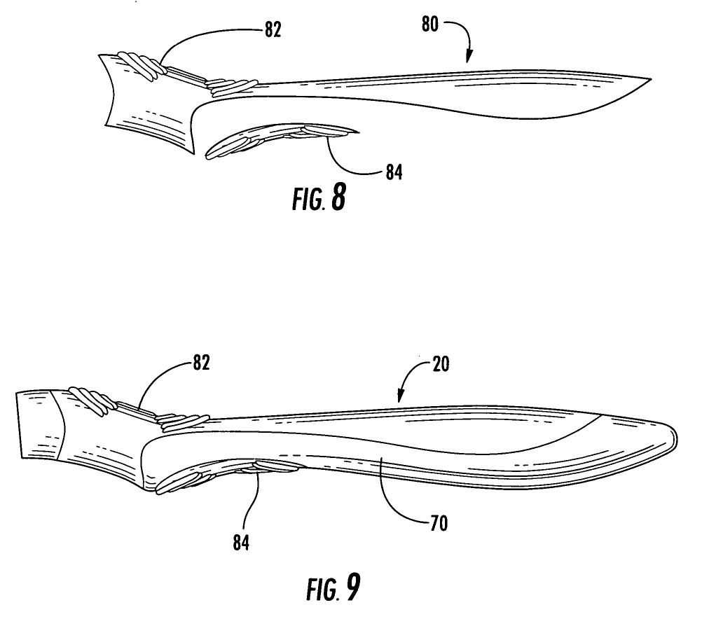

The handle 20, shown assembled in FIG. 9, preferably includes a shell component 70 (FIGS. 7A-7C) and a grip component 80 (FIG. 8) preferably overmolded onto the shell component. With reference to FIGS. 7A-7C, the shell component 70 is preferably of one-piece molded plastic construction and includes a blind bore 71 with an opening 72 defined at a front end thereof. Various portions 73 of the shell component 70 are preferably recessed so as to define sites for receiving the grip component 80 such that a smooth interface is provided between exterior surfaces of the grip component 80 and exposed surfaces of the shell 70 and to render an aesthetically pleasing appearance.

With reference to FIGS. 7B and 7C, the bore 71 is configured for statically seating the gripper retainer 18 and rotatably retaining the cap 14 such that the cap 14 may be rotated between the first position in which the gripper/retainer assembly is exposed to the first diameter D1 of the cap 14, and the second position in which the gripper/retainer assembly is exposed to the second diameter D2 of the cap 14.

In this regard, the blind end of the bore 71 is configured to define a retainer receptacle 74 for receiving the gripper retainer 18 so as to maintain the retainer 18 static relative to the handle 20. The receptacle 74 includes a portion 74a for receiving the notch 68 and a larger portion 74b for receiving a portion of the retainer proximate the bend 62 thereof.

In addition, a cap receptacle 75 is defined between the receptacle 74 and the opening 72 of the blind bore 71 for rotatably receiving the cap 14. The receptacle 75 includes a portion 75a for receiving the shaft extension 45a and a larger portion 75b for receiving the remainder of the shaft 45. The portion 75a is sized so that one edge of the shaft extension 45a contacts one edge of the portion 75a when the cap 14 is in the first position. The cap 14 may then be rotated to the second position, wherein the opposite edge of the shaft extension 45a contacts the opposite edge of the portion 75. Thus, the cap may be freely rotated between the first and second positions, with such rotation preferably being encompassed by only a partial rotation of the cap 14 relative to the handle 20, such as an approximately one-quarter turn or revolution. A pair of projections 76a and 76b are preferably located within the portion 75b for cooperating with the mounting tabs 46a and 46b of the cap 14 so as to facilitate snap-fitting of the cap 14 to the handle 20 and to retain the cap 14 in the second position until force is applied to rotate it back to the first position.

With reference to FIG. 8, the grip component preferably includes an upper grip 82 and a lower grip 84, each preferably molded of a flexible polymeric material, such as a rubber, and including rugous topography to facilitate gripping of the handle. With reference to FIG. 9, the handle 20 is shown with the grip component 80 installed on the shell component 70, preferably by overmolding.

The handle system 10 provides a reusable handle that can be used with disposable flossers, such as flosser 12, to facilitate use thereof. To install the flosser, the cap 14 is located in the first position so that the larger D1 diameter of the cap 14 is oriented relative to the gripper/retainer assembly received within the cap. The handle 22 of the flosser 12 is passed through the aperture 43 of the cap 14 so that the handle 22 is received within the channel 58 of the gripper 16. The cap 14 is then rotated to the second position to bear the sidewall portions 44a and 44b against the gripper/retainer assembly to squeeze the gripper 16 against the handle 22 of the flosser 12. The flosser 12 is thus firmly retained by the handle assembly 10. The cap 14 may thereafter be returned to the first position and the flosser 12 removed.

The foregoing description of certain exemplary embodiments of the present invention has been provided for purposes of illustration only, and it is understood that numerous modifications or alterations may be made in and to the illustrated embodiments without departing from the spirit and scope of the invention as defined in the following claims.

What is claimed is:

1. A flossing system, comprising:
a flosser having an elongate flosser handle; and
a handle system for fixedly and replaceably receiving the flosser handle, the handle system comprising an auxiliary handle, a cap rotatably connected to the auxiliary handle between a first position and a second position and having a first interior dimension and a second smaller interior dimension, and a flexible member configured for receiving a portion of the flosser handle and received within a retainer statically positioned relative to the auxiliary handle,
wherein when the cap is in the first position the first interior dimension of the cap cooperates with the retainer to enable the flosser handle to be freely insertable through an aperture of the cap for receipt by the flexible member and wherein when the cap is rotated to the second position the second and smaller interior dimension of the cap bears against portions of the retainer to urge the flexible member against the flosser handle to fixedly restrain the flosser handle from movement relative to the handle system.

2. The flossing system of claim 1, wherein the flexible member comprises a substantially U-shaped member.

3. The flossing system of claim 1, wherein the retainer is substantially U-shaped.

4. The flossing system of claim 1, wherein the auxiliary handle includes a blind bore into which the retainer is inserted.

5. The flossing system of claim 4, wherein the blind bore includes a receptacle configured for engaging a portion of the retainer for maintaining the retainer in static engagement with the blind bore.

6. The flossing system of claim 4, wherein the blind bore includes a receptacle configured for receiving a portion of the cap and for limiting rotation of the cap between the first and second positions.

7. The flossing system of claim 1, wherein the auxiliary handle includes a shell component and a flexible grip component installed on the shell component.

8. A handle system for use with a disposable flosser having an elongate flosser handle to fixedly and replaceably receive the flosser, the system comprising:
an auxiliary handle;
a cap rotatably connected to the auxiliary handle between a first position and a second position and having a first interior dimension and a second smaller interior dimension;
a flexible member configured for receiving a portion of the flosser handle and received within a retainer statically positioned relative to the auxiliary handle, and
wherein when the cap is in the first position the first interior dimension of the cap cooperates with the retainer to enable the flosser handle to be freely insertable through an aperture of the cap for receipt by the flexible member and wherein when the cap is rotated to the second position, the second and smaller interior dimension of the cap is urgeable against portions of the retainer to urge the flexible member against the flosser handle to fixedly restrain the flosser handle from movement relative to the handle system.

9. A handle system for use with a disposable flosser having an elongate flosser handle to fixedly and replaceably receive the flosser, the system comprising: an auxiliary handle having a blind bore; a cap movably mounted to the auxiliary handle adjacent the blind bore and defining a channel; and a flexible member received within the channel and the blind bore of the auxiliary handle and configured for receiving a portion of the flosser handle, wherein the cap is movable between first and second positions to urge the flexible member against the flosser handle when the flosser handle is received within the flexible member so as to frictionally retain the flosser handle.

10. The handle system of claim 9, wherein the cap is rotatably mounted.

11. The handle system of claim 9, further comprising a retainer member statically positioned relative to the auxiliary handle and configured for receiving the flexible member.
